(19) United States
(12) Patent Application Publication
(10) Pub. No.: US 2019/0239493 A1
(43) Pub. Date: Aug. 8, 2019

(54) HEAT EXCHANGE SYSTEM FOR WATER TEMPERATURE CONTROL

(71) Applicants: LIANG-CHUAN LIU, NEW TAIPEI CITY (TW); MING-CHUN LEE, TAIPEI CITY (TW)

(72) Inventors: LIANG-CHUAN LIU, NEW TAIPEI CITY (TW); MING-CHUN LEE, TAIPEI CITY (TW)

(21) Appl. No.: 15/891,666

(22) Filed: Feb. 8, 2018

(51) Int. Cl. A01K 63/06; A01K 63/00

(52) U.S. Cl. CPC A01K 63/065; A01K 2227/40; A01K 63/006

(57) ABSTRACT

A heat exchange system includes a water flow casing shaped like an open box and having a flow space defined therein and water inlet/outlet pipes for guiding a water into the flow space or for guiding the water out of the flow space, a thermoelectric cooling chip fastened to the open side of the water flow casing with the cold side facing toward the flow space for cooling the water, a heat dissipating unit fastened to the opposing hot side of the thermoelectric cooling chip for dissipating heat from the thermoelectric cooling chip, and a water pump adapted for pumping the water through the water inlet/outlet pipes and flow space of the water flow casing for cooling.

### BACKGROUND OF THE INVENTION

### 1. Field of the Invention

The present invention relates to heat exchange technology and more particularly, to a heat exchange system suitable for use in a sea water aquarium for water temperature control.

### 2. Description of the Related Art

A conventional water temperature control system for aquarium generally comprises a hollow metal housing, a thermoelectric cooling chip, a radiation fin set and a fan. In operation, a water pump pumps water from the aquarium through a water delivery pipe in to an internal loop in the hollow metal housing for enabling the cold side of the thermoelectric cooling chip to absorb heat from the circulating water through the hollow metal housing. At the same time, the heat produced by the hot side of the thermoelectric cooling chip is transferred to the radiation fin set and dissipated into the outside open air by the fan. According to this prior art design, the temperature of the circulating water is transferred through the hollow metal housing to the cold side of the thermoelectric cooling chip.

Since the cold side of the thermoelectric cooling chip is not disposed in direct contact with the circulating water, the cooling efficiency is lowered. Further, in hot summer, surrounding temperature can be higher than the water temperature in the aquarium, the housing of the aquarium will absorb the water temperature and the surrounding temperature, and the hollow metal housing will also absorb the surrounding temperature. Under this condition, the cold side of the thermoelectric cooling chip needs to absorb the temperature of the circulating water in the hollow metal housing as well as the surrounding temperature absorbed by the hollow metal housing, increasing the load, leading to increased power consumption. Thus, the working of the radiation fin set and the fan in dissipating heat is heavy and not efficient. Further, if sea water is used in the aquarium, the hollow metal housing is easy to have corrosion, shortening the lifespan, lowering the heat exchange efficiency, increasing the cost and slowing down the productivity.

### SUMMARY OF THE INVENTION

The present invention has been accomplished under the circumstances in view. It is one object of the present invention to provide a heat exchange system for use in a sea water aquarium for water temperature control, which comprises a water flow casing, a thermoelectric cooling chip, a heat dissipating unit and a water pump. The water flow casing is made in the form of an open box, comprising a flow space, a plurality of water inlet/outlet pipes selectively for guiding a water into the flow space or for guiding water out of the flow space. The thermoelectric cooling chip is fastened to the water flow casing to close the flow space, comprising a cold side facing toward the flow space for cooling water in the flow space and a hot side opposite to the cold side. The heat dissipating unit is fastened to the hot side of the thermoelectric cooling chip for dissipating heat from the hot side of the thermoelectric cooling chip. The water pump is adapted for pumping water through the water inlet/outlet pipes and the flow space of the water flow casing. The water flow casing is made is made of a low thermal conductivity material so that the internal water temperature is free from the interference of external surrounding temperature. Further, the water flow casing is durable and not easy to produce corrosion, enhancing the performance of the thermoelectric cooling chip for heat exchange efficiently, and saving system power consumption.

Since the thermoelectric cooling chip is fastened to the open side of the water flow casing with the cold side thereof disposed in direct contact with water in the flow space for cooling water temperature, increasing heat exchange efficiency.

Since the water flow casing is made is made of is made of a low thermal conductivity metal, plastic, fiberglass or composite material that is durable and not easy to produce corrosion, the water in the water flow casing is free from the interference of external surrounding temperature, thus, the water temperature can be quickly controlled, the performance of the thermoelectric cooling chip can be enhanced, saving much power consumption.

### BRIEF DESCRIPTION OF THE DRAWINGS

FIG. 1 is an exploded view of a part of a heat exchange system in accordance with a first embodiment of the present invention.

FIG. 2 is a schematic assembly view of the heat exchange system in accordance with the first embodiment of the present invention.

FIG. 3 illustrates one form of the water flow casing of the heat exchange system in accordance with the first embodiment of the present invention.

FIG. 4 illustrates another form of the water flow casing of the heat exchange system in accordance with the first embodiment of the present invention.

FIG. 5 is a schematic sectional view of a heat exchange system in accordance with a second embodiment of the present invention.

FIG. 6 is an exploded view of a part of a heat exchange system in accordance with a third embodiment of the present invention.

FIG. 7 is a schematic sectional assembly view of the heat exchange system in accordance with the third embodiment of the present invention.

FIG. 8 is a schematic sectional assembly view of the heat exchange system in accordance with the fourth embodiment of the present invention.

### DETAILED DESCRIPTION OF THE PREFERRED EMBODIMENT

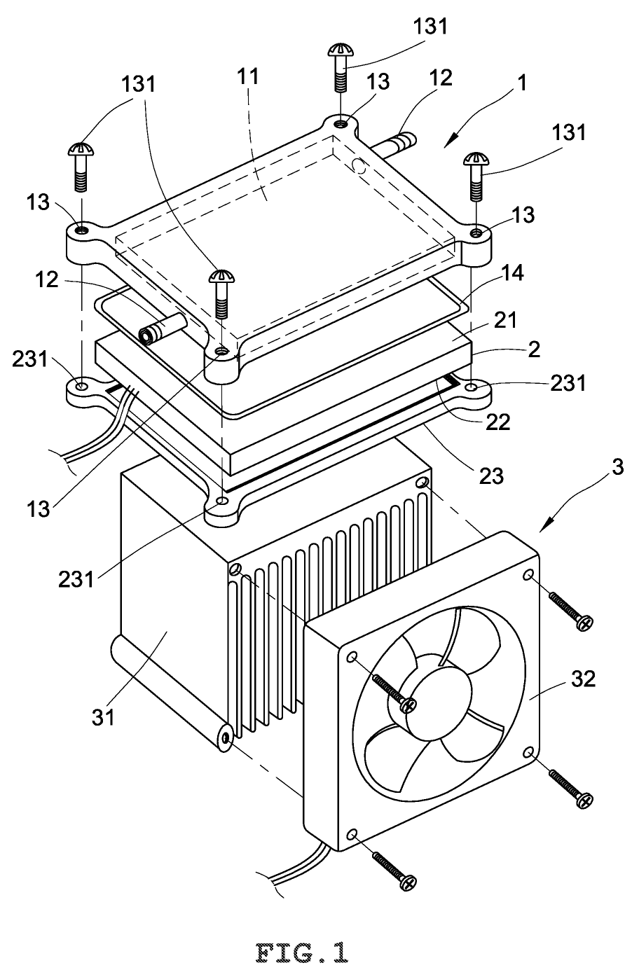

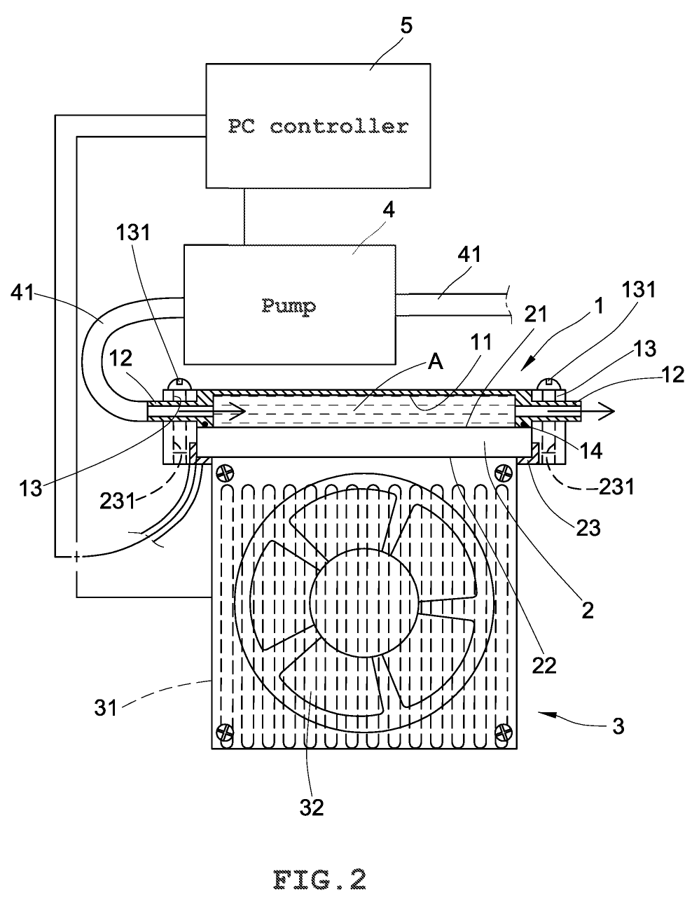

Referring to FIGS. 1 and 2, a heat exchange system for water temperature control in accordance with a first embodiment of the present invention is adapted for use in an aquarium for controlling the temperature of sea water in the aquarium. The heat exchange system comprises a water flow casing (1) made of a low thermal conductivity material, a thermoelectric cooling chip (2) and a heat dissipating unit (3). The water flow casing (1) is shaped like an open box comprising a flow space (11), and a plurality of water inlet/outlet pipes (12) located on one or two opposite sides thereof for guiding water into or out of the flow space (11). The thermoelectric cooling chip (2) is fastened to the water flow casing (1) to seal the open side of the open box-shaped water flow casing (1), comprising a cold side (21) that faces toward the flow space (11) and an opposing hot side (22). The heat dissipating unit (3) is mounted to the hot side (22) of the thermoelectric cooling chip (2), comprising a heat sink (31) disposed in contact with the hot side (22) of the thermoelectric cooling chip (2) and a fan (32). In application, a water pump (4) is operated to pump water (A) through a water delivery pipe (41) and one water inlet/outlet pipe (12) of the water flow casing (1) into the flow space (11), enabling the water (A) in the flow space (11) to be disposed in contact with the cold side (21) of the thermoelectric cooling chip (2) for heat exchange. Thus, the temperature of the water (A) is lowered. During the operation of the thermoelectric cooling chip (2), the heat energy released from the hot side (22) of the thermoelectric cooling chip (2) is dissipated into the outside open air by the heat dissipating unit (3). Further, the water flow casing (1) is made of a low thermal conductivity metal, plastic, fiberglass or composite material that is durable and not easy to produce corrosion, enhancing the performance of the thermoelectric cooling chip (2). The heat exchange system further comprises a PC controller (5) for monitoring the temperature of the water (A) and controlling the operation of the thermoelectric cooling chip (2) and the heat dissipating unit (3). When the temperature of the water (A) surpasses a predetermined value, the PC controller (5) controls the flowrate of the water pump (4), increases the thermal output of the thermoelectric cooling chip (2) and drives the fan (32) of the heat dissipating unit (3) to cool the heat sink (31), thus, the temperature of the water (A) can be efficiently controlled, saving power consumption. Further, the heat dissipating unit (3) can be selectively a water cooling design or an air cooling design. In this embodiment, the heat dissipating unit (3) is an air cooling design.

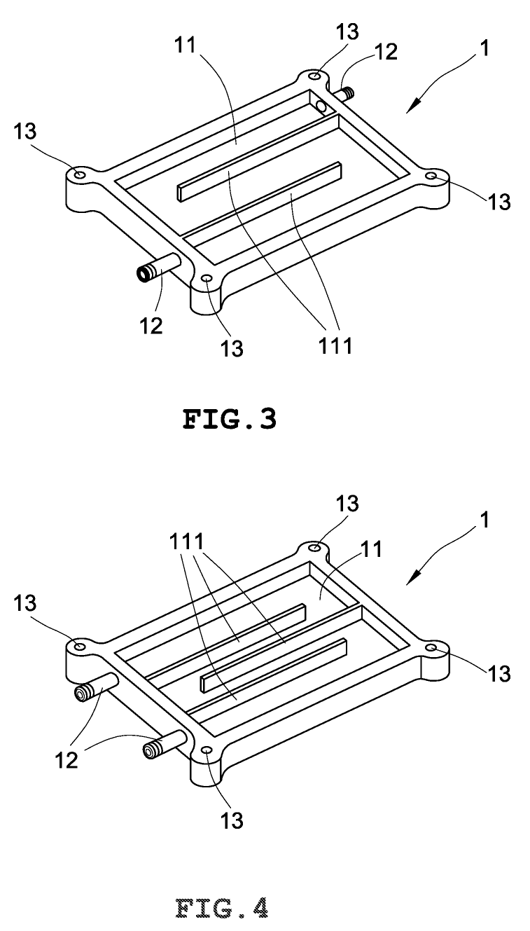

Referring to FIG. 3, in one embodiment of the present invention, two water inlet/outlet pipes (12) are arranged on two opposite sides of the water flow casing (1) for water inlet or outlet; a plurality of water baffles (111) are arranged in the flow space (11) of the water flow casing (1) to create a roundabout flow path for guiding the water (A) to flow through the flow space (11) in a curved manner.

Referring to FIG. 4, in one embodiment of the present invention, two water inlet/outlet pipes (12) are arranged on one side of the water flow casing (1) for water inlet or outlet; a plurality of water baffles (111) are arranged in the flow space (11) of the water flow casing (1) to create a roundabout flow path for guiding the water (A) to flow through the flow space (11) in a curved manner.

The heat exchange system further comprises a clamping frame (23) fastened to the water flow casing (1) to secure the thermoelectric cooling chip (2) between the water flow casing (1) and the clamping frame (23). Further, the water flow casing (1) comprises a plurality of mounting holes (13) respectively located in the four corners thereof. The clamping frame (23) comprises a plurality of mounting holes (231). Screws (131) are respectively fastened to the mounting holes (13) of the water flow casing (1) and the mounting holes (231) of the clamping frame (23) to affix the water flow casing (1), the thermoelectric cooling chip (2) and the clamping frame (23) together. Further, a water gasket (14) is mounted between the water flow casing (1) and the thermoelectric cooling chip (2) to seal the gap.

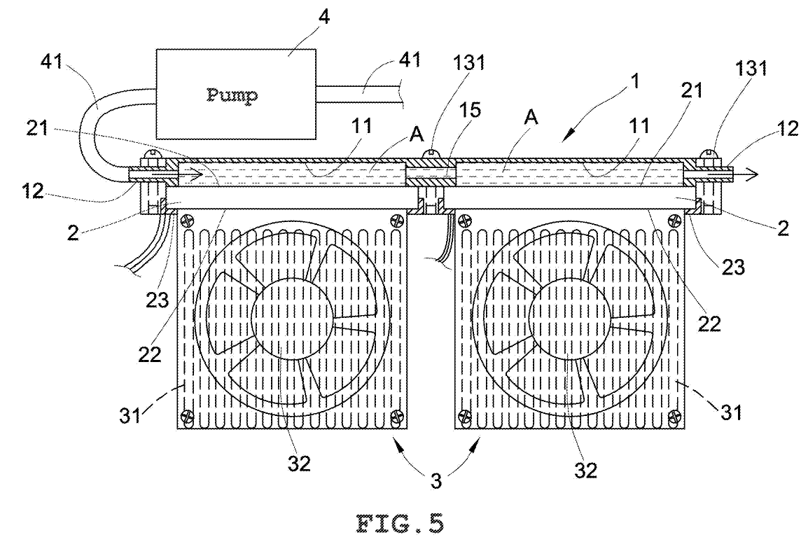

In the embodiment shown in FIG. 5, the water flow casing (1) defining therein two separated flow spaces (11), and a water passage (15) in communication between the two flow spaces (11); two thermoelectric cooling chips (2) are fastened to the water flow casing (1) with the respective cold sides (21) thereof facing toward the respective flow spaces (11) for cooling the water (A) that flows through the flow spaces (11); two heat dissipating units (3) are respective fastened to the hot sides (22) of the thermoelectric cooling chips (2) for dissipating heat energy from the hot sides (22) of the thermoelectric cooling chips (2).

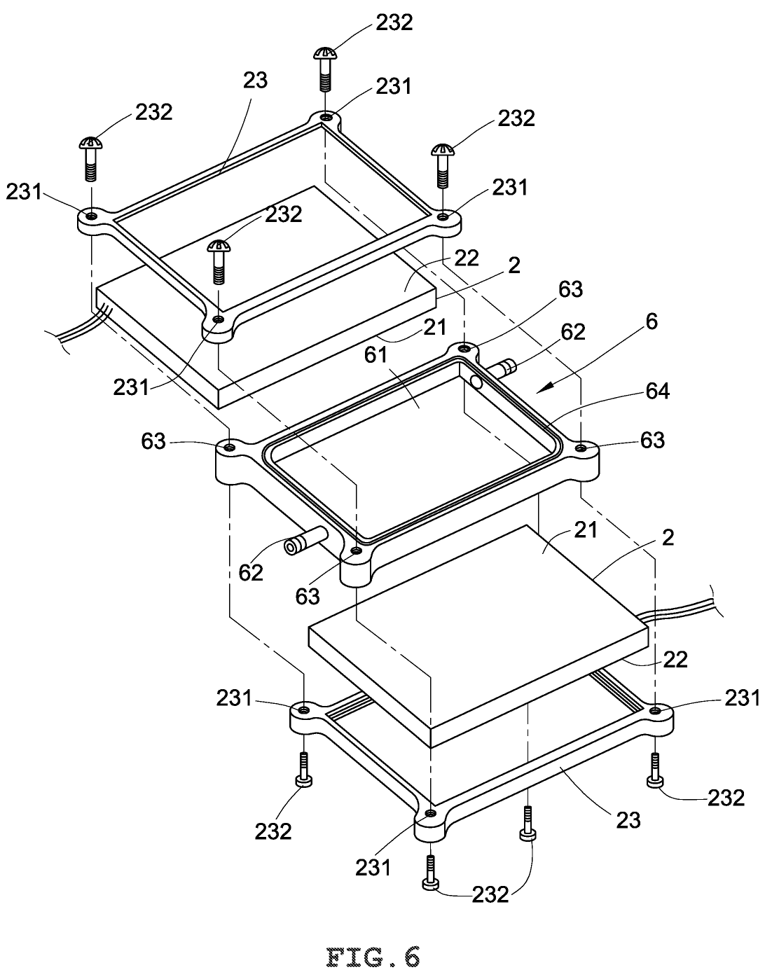

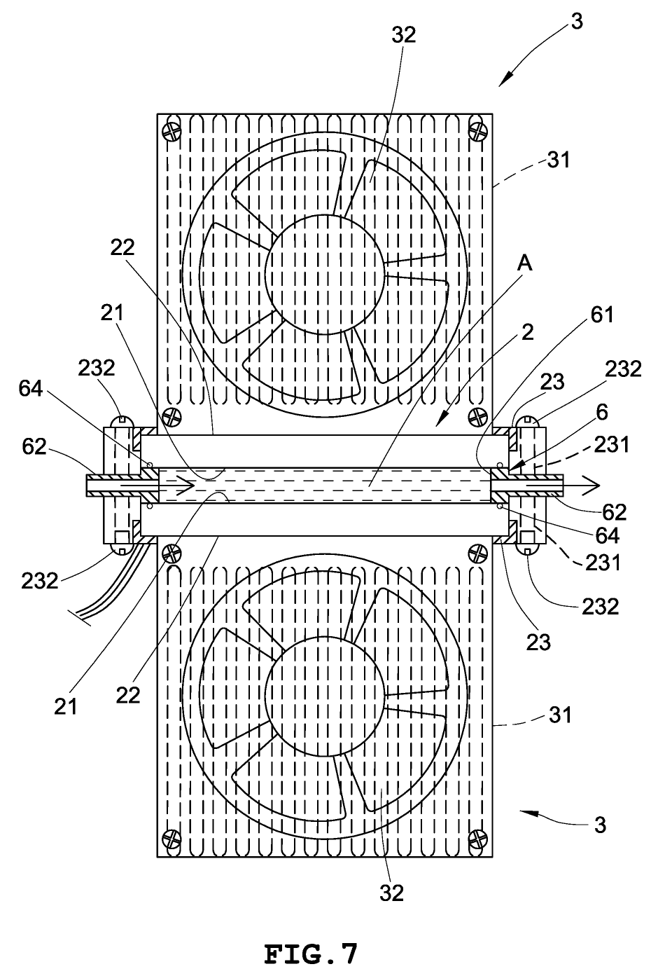

In the embodiment shown in FIGS. 6 and 7, the heat exchange system comprises a water flow casing (6), two thermoelectric cooling chips (2) and two heat dissipating units (3). The water flow casing (6) is made of a low thermal conductivity material in the shape of an open frame, comprising a flow space (61), and a plurality of water inlet/outlet pipe (62) located two opposite sides thereof for guiding water into or out of the flow space (61). The two thermoelectric cooling chips (2) are respectively mounted to opposing top and bottom sides of the water flow casing (6), each comprising a cold side (21) that faces toward the flow space (61) and an opposing hot side (22). The heat dissipating units (3) are respectively mounted to the hot sides (22) of the thermoelectric cooling chips (2), each comprising a heat sink (31) disposed in contact with the hot side (22) of the respective thermoelectric cooling chip (2) and a fan (32). In application, a water pump (4) is operated to pump water (A) through a water delivery pipe (41) and one water inlet/outlet pipe (62) of the water flow casing (6) into the flow space (61), enabling the water (A) in the flow space (61) to be disposed in contact with the cold sides (21) of the thermoelectric cooling chips (2) for heat exchange. Thus, the temperature of the water (A) is rapidly lowered. During the operation of the thermoelectric cooling chips (2), the heat energy released from the hot sides (22) of the thermoelectric cooling chips (2) is dissipated into the outside open air by the heat dissipating units (3). Further, the water flow casing (6) is made of a low thermal conductivity metal, plastic, fiberglass or composite material that is durable and not easy to produce corrosion, enhancing the performance of the thermoelectric cooling chips (2). The heat exchange system further comprises a PC controller (5) for monitoring the temperature of the water (A) and controlling the operation of the thermoelectric cooling chips (2) and the heat dissipating units (3). When the temperature of the water (A) surpasses a predetermined value, the PC controller (5) controls the flowrate of the water pump (4), increases the thermal output of the thermoelectric cooling chips (2) and drives the fans (32) of the heat dissipating units (3) to cool the heat sinks (31), thus, the temperature of the water (A) can be efficiently controlled, saving power consumption.

The heat exchange system further comprises two clamping frames (23) respectively fastened to the opposing top and bottom sides of water flow casing (6) to secure the thermoelectric cooling chips (2) between the water flow casing (6) and the clamping frames (23). Further, the water flow casing (6) comprises a plurality of mounting holes (63) respectively located in the four corners thereof. The clamping frames (23) each comprises a plurality of mounting holes (231). Screws (232) are respectively fastened to the mounting holes (63) of the water flow casing (6) and the mounting holes (231) of the clamping frame (23) to affix the water flow casing (6), the thermoelectric cooling chips (2) and the clamping frames (23) together. Further, a water gasket (64) is mounted between the water flow casing (6) and each thermoelectric cooling chip (2) to seal the gap.

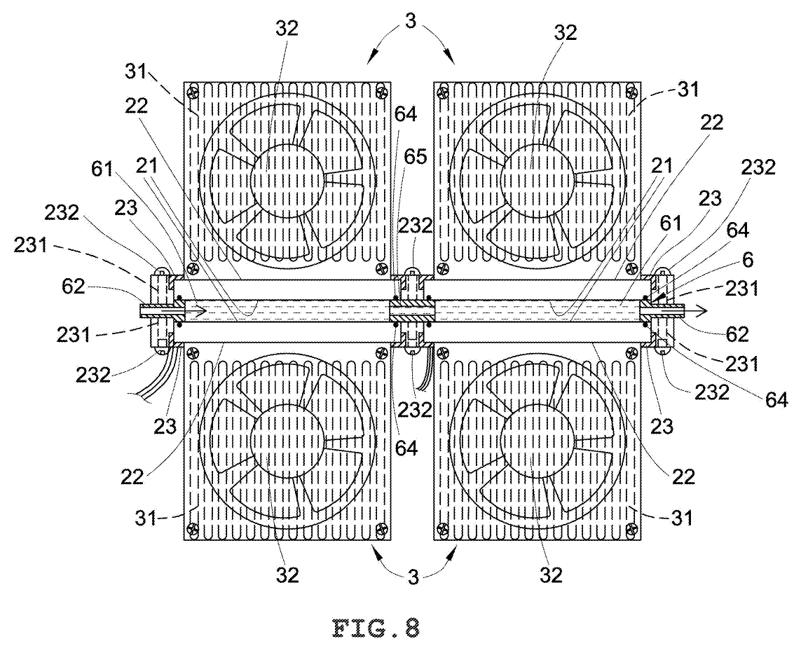

In the embodiment shown in FIG. 8, the water flow casing (6) defining therein two separated flow spaces (61), and a water passage (65) in communication between the two flow spaces (61); two sets of thermoelectric cooling chips (2) are respectively fastened to the opposing top and bottom sides of the water flow casing (6) with the respective cold sides (21) thereof facing toward the respective flow spaces (61) for cooling the water (A) that flows through the flow spaces (61);

two sets of heat dissipating units (3) are respective fastened to the hot sides (22) of the thermoelectric cooling chips (2) for dissipating heat energy from the hot sides (22) of the thermoelectric cooling chips (2).

Further, the thermoelectric cooling chip (2) can be a heat source, such as CPU that is fastened to the open side of the water flow casing (1), creating a high-performance water cooling system.

In conclusion, the heat exchange system of the present invention is practical for using to control water temperature efficiently, saving power consumption.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A heat exchange system, comprising:
a water flow casing made in the form of an open box, comprising at least one flow space, a plurality of water inlet/outlet pipes selectively for guiding a water into said at least one flow space or for guiding said water (A) out of said at least one flow space;
at least one thermoelectric cooling chip respectively fastened to said water flow casing, each said thermoelectric cooling chip comprising a cold side facing toward one said flow space for cooling said water and a hot side opposite to said cold side;
at least one heat dissipating unit fastened to said at least one thermoelectric cooling chip for dissipating heat from the said hot side of each said thermoelectric cooling chip; and
a water pump adapted for pumping said water through said water inlet/outlet pipes and said at least one flow space of said water flow casing.

2. The heat exchange system as claimed in claim 1, wherein said water flow casing comprises two said flow spaces and a water passage disposed in communication with the two said flow spaces; two said thermoelectric cooling chips are fastened to said water flow casing with the cold sides thereof respectively disposed to face toward the respective two said flow spaces for direct contact with said water; two said heat dissipating units are respectively fastened to the said hot sides of the two said thermoelectric cooling chips.

3. The heat exchange system as claimed in claim 1, wherein said water flow casing is made of a low thermal conductivity material selected from the group of metal, plastic, fiberglass and composite materials.

4. The heat exchange system as claimed in claim 1, further comprising a PC controller adapted for monitoring the temperature of said water and controlling the operation of said at least one thermoelectric cooling chip and said at least one heat dissipating unit.

5. The heat exchange system as claimed in claim 1, wherein said water flow casing further comprises at least one water baffle disposed in said flow space.

6. The heat exchange system as claimed in claim 1, further comprising a clamping frame fastened to said water flow casing to secure said at least one thermoelectric cooling chip in position, said clamping frame comprising a plurality of mounting holes respectively fastened to respective mounting holes of said water flow casing by respective screws.

7. A heat exchange system, comprising:
a water flow casing made in the form of an open frame, comprising at least one flow space cutting through opposing top and bottom sides thereof, a plurality of water inlet/outlet pipes selectively for guiding a water into said at least one flow space or for guiding said water out of said at least one flow space;
a plurality of thermoelectric cooling chips respectively fastened to the opposing top and bottom side of said water flow casing, each said thermoelectric cooling chip comprising a cold side facing toward one said flow space for cooling said water and a hot side opposite to said cold side;
a plurality of heat dissipating units respectively fastened to said thermoelectric cooling chips for dissipating heat from the said hot sides of said thermoelectric cooling chips; and
a water pump adapted for pumping said water through said water inlet/outlet pipes and said at least one flow space of said water flow casing.

8. The heat exchange system as claimed in claim 7, wherein said water flow casing comprises two said flow spaces and a water passage disposed in communication with the two said flow spaces; two sets of said thermoelectric cooling chips are respectively fastened to the opposing top and bottom sides of said water flow casing with the cold sides thereof respectively disposed to face toward the respective two said flow spaces for direct contact with said water; two sets of said heat dissipating units are respectively fastened to the said hot sides of said thermoelectric cooling chips.

9. The heat exchange system as claimed in claim 7, wherein said water flow casing is made of a low thermal conductivity material selected from the group of metal, plastic, fiberglass and composite materials.

10. The heat exchange system as claimed in claim 7, further comprising a PC controller adapted for monitoring the temperature of said water and controlling the operation of said thermoelectric cooling chips and said heat dissipating units.
